(19) United States
(12) Patent Application Publication
(10) Pub. No.: US 2018/0121038 A1
(43) Pub. Date: May 3, 2018

(54) CONTEXTUAL CANVASES FOR A COLLABORATIVE WORKSPACE ENVIRONMENT

(71) Applicant: Microsoft Technology Licensing, LLC, Redmond, WA (US)

(72) Inventors: William James Bliss, Bellevue, WA (US); Larry Jin, Bellevue, WA (US); Richard Taylor, Sammamish, WA (US); Pedro DeRose, Redmond, WA (US); Brian MacDonald, Sammamish, WA (US); Mira Lane, Bellevue, WA (US)

(73) Assignee: Microsoft Technology Licensing, LLC, Redmond, WA (US)

(21) Appl. No.: 15/445,524

(22) Filed: Feb. 28, 2017

Related U.S. Application Data
(60) Provisional application No. 62/416,069, filed on Nov. 1, 2016.

(51) Int. Cl. G06F 3/0482; G06F 3/0481

(52) U.S. Cl. CPC G06F 3/0482; G06F 3/04817

(57) ABSTRACT

Described herein is a system and methods for enabling a user to seamlessly switch between different workspaces, groups and/or conversations is a collaborative workspace environment using a set of contextual canvases. The canvases are provided in a user interface and are associated with different contexts. Further, each canvas is used to display an associated entity. Thus, when a new context in the collaborative workspace environment is selected, the canvases are updated and used to display entities that are related to or otherwise associated with the newly selected context.

### CROSS-REFERENCE TO RELATED APPLICATION

This application claims priority to U.S. Provisional Application No. 62/416,069, entitled “Contextual Canvases for a Collaborative Workspace Environment,” filed on Nov. 1, 2016. the entire disclosure of which is hereby incorporated by reference in its entirety.

### BACKGROUND

In current collaborative workspace environments, there is no notion of allowing a user to seamlessly switch between different tasks in various groups the user may be associated with. For example, if a user is involved with multiple groups, the collaborative workspace environment has a single portal page that is directed to that group. If the user wants to switch to another group, the user typically must close the portal page and open a new portal page that is associated with the new group.

It is with respect to these and other general considerations that embodiments have been described. Also, although relatively specific problems have been discussed, it should be understood that the embodiments should not be limited to solving the specific problems identified in the background.

### SUMMARY

This disclosure generally relates to a system and methods for enabling a user to seamlessly switch between different workspaces, groups and/or conversations (e.g., contexts) in a collaborative workspace environment. More specifically, the present disclosure describes a user interface that enables one or more canvases to be created and be associated with the different groups. The canvases have a workspace in which content specific to the canvas is displayed. The canvases are contextual in that they change based on the particular channel, workspace or group the user is currently accessing.

For example, if the user is working in one workspace, a first set of canvases is displayed. Each canvas in the first set of canvases is associated with specific conversations, documents, subject matter, tasks, dashboards and so on that correspond to the workspace. For example, content is filtered and displayed in a workspace associated with the canvas based on the context of the channel or the context of the tab. When the user switches from one workspace to a second workspace, a second set of canvases is displayed. Each canvas in the second set of canvases provides access to a different set of conversations, documents, tasks, subject matter, dashboards and so on that correspond to the second channel. Use of the canvases in such a way enables the user to simply switch between the canvases and access the content as if the content was part of a single application (even though the content may be provided by different services).

In aspects, a system having at least one processing unit and a memory is disclosed. The memory stores computer executable instructions which, when executed by the at least one processing unit, causes the system to provide a user interface for a collaborative workspace environment. The user interface includes a channel selection area that displays one or more channels associated with different groups and a canvas selection area that displays one or more customizable canvases associated with the one or more contexts. Each of the one or more canvases is selectable. Further, selection of one of the one or more canvases causes a corresponding workspace to be displayed. The corresponding workspace displays content that corresponds to the selected one of the one or more canvases and the context. The user interface also includes a conversation pane that is associated with at least one of the one or more contexts. The conversation pane receives and displays input associated with at least one of the one or more canvases.

Also disclosed is a method for providing a user interface of a collaborative workspace environment. The method includes receiving a selection of a context in the user interface of the collaborative workspace environment and displaying a set of selectable canvases that are associated with the context. When a selection of at least one canvas is received, content that is associated with the selected canvas and the context is provided in a workspace associated with the canvas. Thus, each canvas is used to display or otherwise provide content that is specific to the currently selected canvas.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system for providing a collaborative workspace environment.

FIG. 2 illustrates an example user interface having various contexts and selectable canvases.

FIG. 3 illustrates the example user interface of FIG. 2 when a different canvas has been selected.

FIG. 4 illustrates the example user interface of FIG. 2 in which a new canvas has been added to the user interface.

FIG. 5 illustrates the example user interface of FIG. 2 in which a new conversation thread has been added to the user interface when the new canvas of FIG. 4 was added.

FIG. 6 illustrates that the example user interface has a different set of canvases when a different context has been selected.

FIG. 7 illustrates how a service may be used to create a canvas in the user interface.

FIG. 8 illustrates an example user interface in which a canvas has been added.

FIG. 9 illustrates a method for displaying contextual canvases in a collaborative workspace environment.

FIG. 10 is a block diagram illustrating example physical components of a computing device with which aspects of the disclosure may be practiced.

FIGS. 11A and 11B are simplified block diagrams of a mobile computing device with which aspects of the present disclosure may be practiced.

FIG. 12 is a simplified block diagram of a distributed computing system in which aspects of the present disclosure may be practiced.

FIG. 13 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

This disclosure generally relates to a user interface for a collaborative workspace environment. In general, the collaborative workspace environment displays or otherwise provides a user access to multiple groups in the collaborative workspace environment that the user is associated with. Each group may be associated with one or more contexts. As used herein, the term “context” means a tenant, a team, a channel, a topic or chat, a conversation and the like. In addition, each context may have an associated workspace that displays content (or an entity) associated with the context. As used herein, the term “entity” means an item within or otherwise provided by service. The entity may be a document, a task, a board and other such content provided by a service. The term “service” may be any product that provides content. For example, a product may be a word processing application, a workflow management application and so on. The service may be a third party service or a local service that the collaborative workspace environment has access to. Once an entity is provided in the workspace, each member of the group or users that access the context, may access, edit, comment, post or otherwise interact with the entity.

The user interface includes canvases that are associated with each context. Canvases in each of the contexts may be added, removed and edited. When a canvas is selected, a workspace associated with the canvas is provided on the user interface. The workspace may be configured to occupy a majority of the user interface, a portion of the user interface, or the entire user interface. In some instances, the workspace may be resizable based on user selection. In other embodiments, multiple canvases, and their associated workspaces, may be displayed simultaneously or concurrently. For example, the canvases may be shown side-by-side, as stacked windows and so on.

As described above, the workspace displays an entity (or entities) that is associated with the particular canvas. For example, in some instances, an entity (e.g., documents, dashboards, conversations or chats, video content, pictures and so on) may be filtered for each canvas. Thus, each workspace, and the entity displayed in that workspace, is unique to that canvas. For example, the entity that is displayed when one canvas is selected is different than the entity that is displayed when a second canvas is selected.

The entity, as well as a state of the entity, that is provided in each canvas is persistent. For example, the context (e.g., a channel) may be configured to store the state of the canvas. Thus, when input is received to switch between canvases (or open or otherwise access the collaborative workspace environment), the state of the entity and the associated canvas are loaded/unloaded by the context.

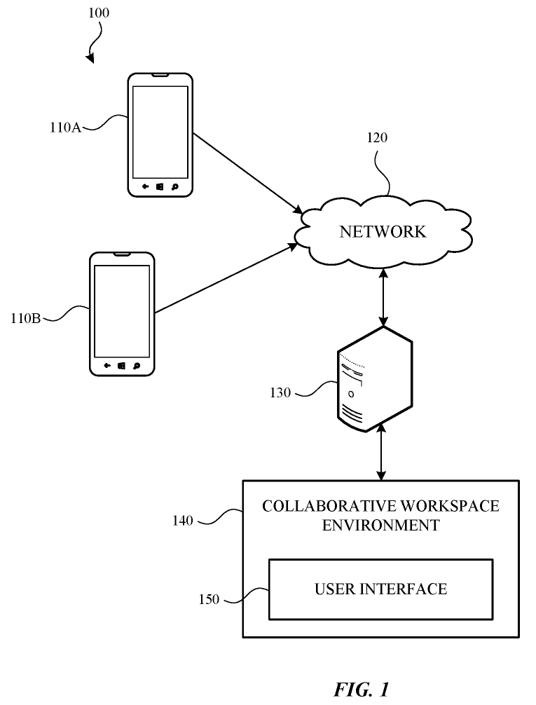

FIG. 1 illustrates an example system 100 for providing a providing a collaborative workspace environment 140 according to an embodiment. In aspects, a client device, such as for example, client device 110A and client device 110B (also referred to as client computing device 110), may access a network 130, or other internet connection, and access the collaborative workspace environment 140 executing on a server computing device 120.

In some embodiments, the client computing device 110 is a personal or handheld computer having both input elements and output elements. For example, the client computing device 110 may be one of: a mobile telephone; a smart phone; a tablet; a phablet; a smart watch; a wearable computer; a personal computer; a desktop computer; a laptop computer; a gaming device/computer (e.g., Xbox); a television; and the like. This list is for example purposes only and should not be considered as limiting. Any suitable client computing device for executing a messaging application may be utilized.

The system 100 is a communication system/service that provides the collaborative workspace environment 140 for users to communicate and collaborate over the network 120. In an example, the collaborative workspace environment 140 provides a configurable and extensible workspace for collaboration between users through a user interface 150 that may comprise a plurality of different views.

Users of the collaborative workspace environment 140 may be include but are not limited to: one or more persons, companies, organizations, departments, virtual teams, ad-hoc groups, vendors, customers, third-parties, etc. The collaborative workspace environment 140 enables visibility and communication between users including users who are organized in teams or groups as well as users/groups outside of a team/group.

More specifically, when a user accesses the collaborative workspace environment 140, the user may have access to one or more groups. Each group may be associated with various contexts that have a particular set of entities. One or more canvases are associated with each context and each canvas has an associated workspace in which an entity, related to or otherwise filtered for the canvas and/or context is displayed. By selecting the various canvases that are displayed, different entities, associated with each canvas, is provided in the workspace.

In some instances, each canvas may be used to provide an entity that multiple users may access, edit, and/or create. The entity may be provided by various services—both local services (e.g., services, applications and products provided or otherwise hosted by the server 120) and external or third party services. Example services include, but are not limited to, word processing applications or services, spreadsheet applications or services, line-of-business (LOB) management services, customer relationship management (CRM) services, debugging services, accounting services, payroll services and so on. In other examples, the entity or the content associated with each canvas may include content from websites and/or applications, such as social media or networking websites, photo sharing websites, video and music streaming websites, messaging applications, search engine websites, sports, news or entertainment websites, and the like.

In some instances, these services may provide robust reporting, analytics, data compilation and/or storage service, etc., whereas other services may provide search engines or other access to data and information, images, videos, document processing and the like.

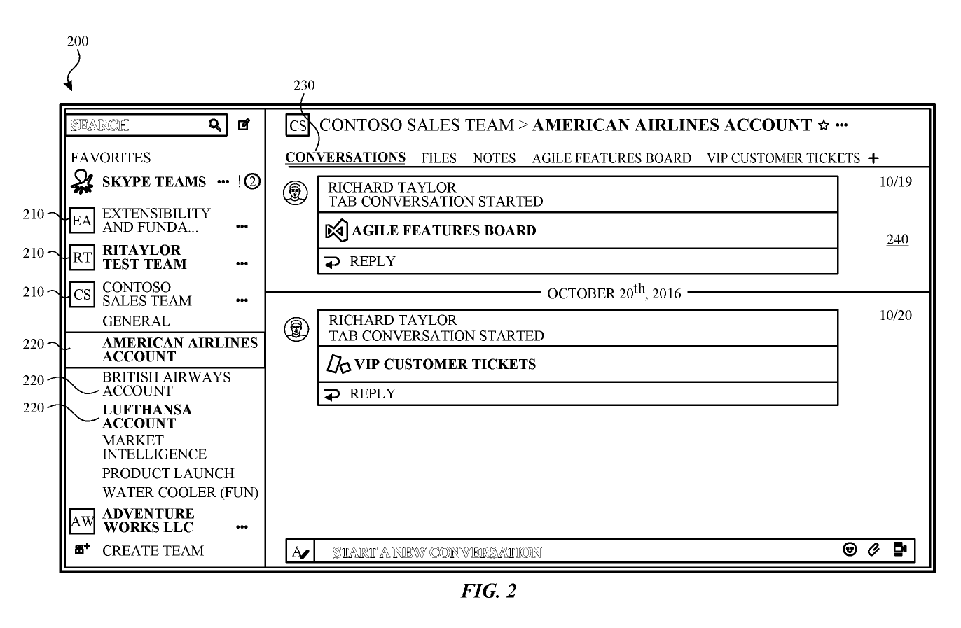

FIG. 2 illustrates an example user interface 200 of a collaborative workspace environment (e.g., the collaborative workspace environment 140 of FIG. 1) of the present disclosure. The user interface 200 may be similar to the user interface 150 described above in FIG. 1.

In aspects, the user interface 200 shows various groups 210. Each group may be associated with multiple members or users. In addition, each group 210 may include one or more contexts 220. For example, the “Contoso sale team group” includes an “American Airlines account” context, a “British Airways account” context, a “Lufthansa account” context, a “Market Intelligence” context, a “Product Launch” context and a “Water Cooler (fun)” context. Each of the groups and contexts shown are for example purposes only.

Once a particular context 220 is selected, various canvases 230 associated with the context 220 are provided in the user interface 200. The canvases are used to display entities or content that has been selected, created or filtered for each canvas.

In this example, the canvases of the Contoso sale team context 220 include a “Conversations” canvas, a “Files” canvas, a “Notes” canvas, an “Agile Features Board” canvas and a “VIP Customer Tickets” canvas. Each canvas 230 is associated with a workspace 240 that provides or otherwise displays an entity. In some instances, the workspace 240 occupies a majority of the user interface 200 to enable the users to have a better view of the entity in each canvas. In other instances, the workspace 240 may be sizable by a user. In yet another implementation, the user interface may be divided into multiple workspaces 240 that each associated with different canvases 230 so the user can view content in two different canvases simultaneously.

As discussed above, an entity that is displayed in each workspace 240 is filtered or otherwise related to a particular canvas 230. For example, the Conversations canvas enables one or more users to start and conduct conversations or chat sessions about content that is associated with the context and/or the various other canvases and entities associated with the contexts.

In the example shown in FIG. 2, the Conversations canvas includes a conversation pane or other such chat area about the VIP Customer Tickets canvas and the Agile Features Board canvas. Using these conversation panes, a member of the group can provide comments and input to entities that are displayed or otherwise associated with the different canvases.

In some embodiments, the comments and input that is provided in the Conversations canvas may also be displayed in the corresponding canvas. For example, if comments or other input is provided in the Agile Features Board conversation pane, those comments or input may also be shown in the Agile Features Board canvas. Likewise, comments or input provided in the Agile Features Board canvas may also be reflected in the Agile Features Board conversation pane in the Conversations canvas 230.

The user interface 200 also enables users to seamlessly switch between the canvases 230 and access different entities that are displayed in the workspace 240 associated with each canvas. In order to switch between canvases, a user simply has to select a particular canvas 230 in the user interface 200 and the associated workspace 240 and its associated entity, is provided to the user.

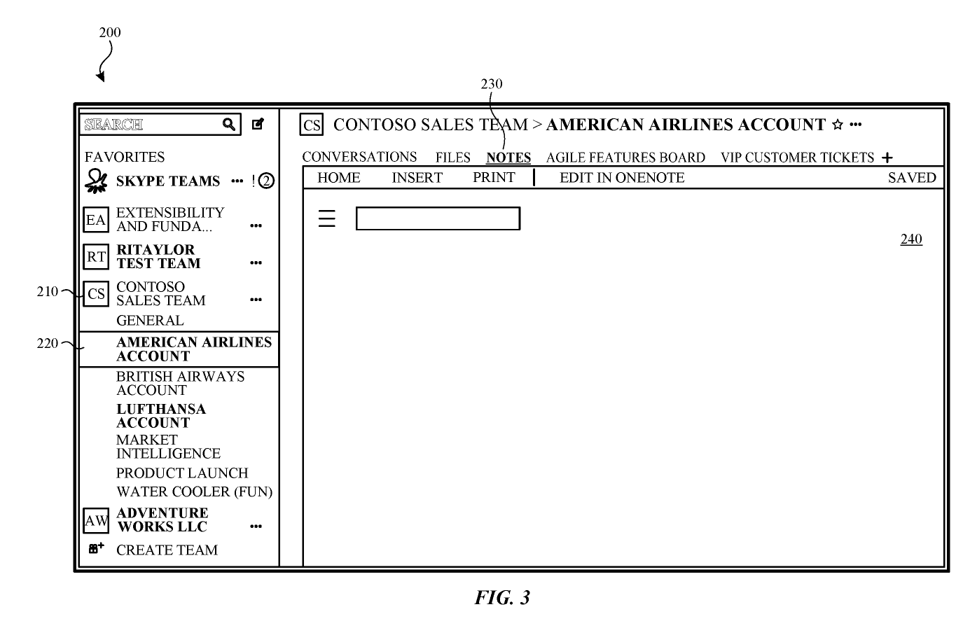

For example, FIG. 3 shows the user interface 200 when a different canvas 230 has been selected. In this example, the “Notes” canvas has been selected. As shown, the “Notes” canvas has a different workspace 240 with different a different entity than the “Conversations” canvas.

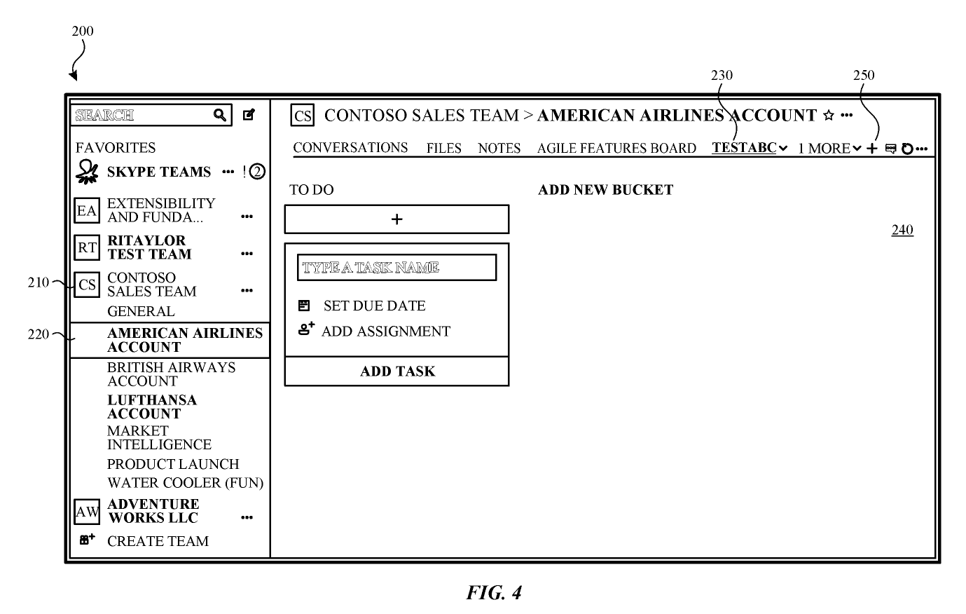

In aspects, a user may provide input to the user interface 200 to create a new canvas. For example, and turning to FIG. 4, the user may provide input to create a new canvas by selecting the “+” icon 250. Once created, the canvas 230 may include an entity from a particular service.

In this example, the user has created a “testabc” canvas. The entity that is associated with this canvas 230 and displayed in the workspace 240 is a task entity. Although tasks are specifically shown, other entities may be provided in each canvas 230. Further, a canvas may be created for any number of entities from various services.

For example, a chat entity may be provided by a local service or a third party service. A canvas may then be created to incorporate the chat entity. In addition, multiple canvases may host multiple different chat or conversation entities. In another embodiment, the chat entity may be a standalone service. In such aspects, the chat entity may incorporate the use of various different canvases such as described above.

In some embodiments, one or more canvases may be created for specified members or users. For example, and continuing with the chat entity example, a canvas may be created to host a chat session between a first member of a group and a second member of the group. The chat may be contextually relevant only for the two members. In another example, a canvas may be created to host a chat or a conversation between multiple users of the collaborative workspace environment.

In another example, the canvas may host a collaborative entity such as, for example, a shared notebook. Further, each canvas may host a separate collaborative entity. In other examples, a canvas can host a document, a spreadsheet, images, video content, sound files, and so on.

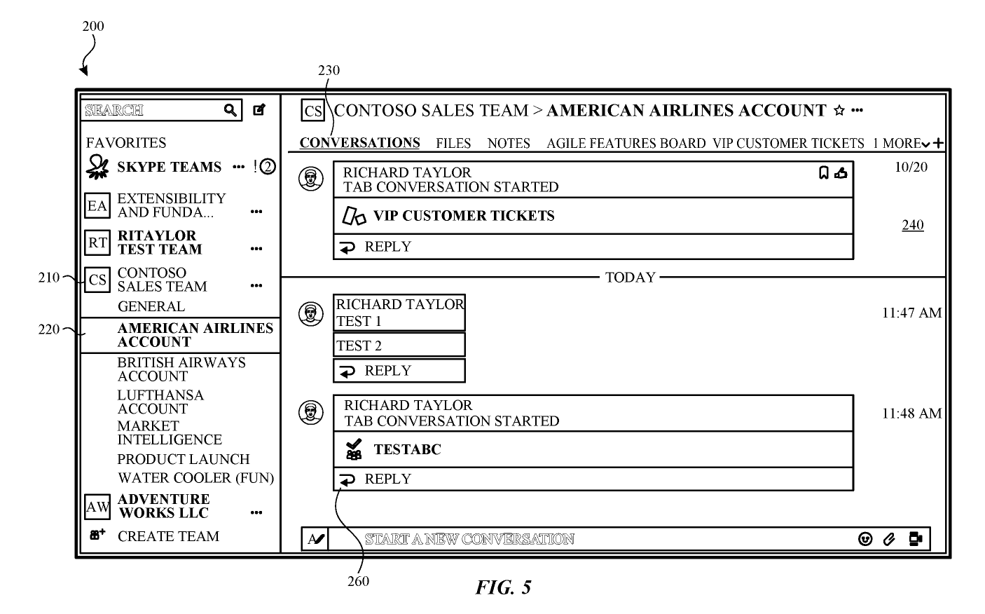

Once the new canvas 230 has been added, a corresponding conversation or chat session may be initialized in the “Conversations” canvas 230. For example, and turning to FIG. 5, a “testabc” conversation pane 260 is now provided in the workspace 240 of the “Conversations” canvas. Using this conversation pane 260, multiple users can discuss, or provide comments about the entity hosted in the “testabc” canvas (as well as entities that are provided in each of the other canvases 230 of the context 220).

As discussed above, each group 210 in the user interface 200 may have its own specialized or unique channel or context 220. Further, each context 220 may have unique canvases 230 that host specified or filtered entities. Additionally, the state of the entities may be persistent. Thus, as a user switches between groups 210, contexts 220 and canvases 230, entities 220, and their respective states, associated with each of the canvases 230, and groups 210 are provided to the user.

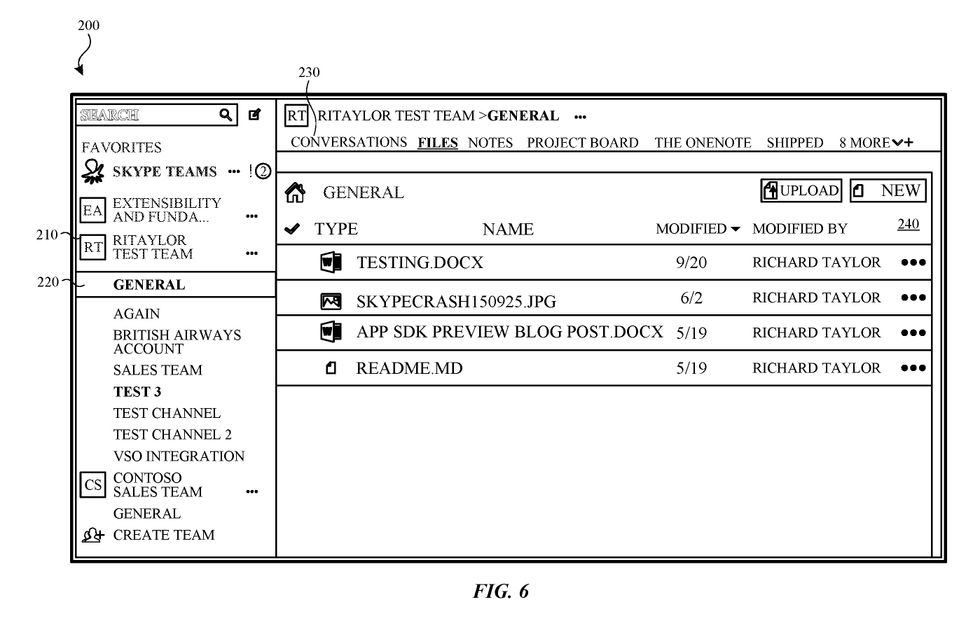

For example, and turning to FIG. 6, a new group 210 has been selected. In this example, the group 210 is the “rtaylor test team” group. This group 210 includes a “General” context, an “again” context, a “British Airways account team” context, a “Sales team” context and so on. As discussed above, each context 220 has its own unique set of canvases 230 with each canvas hosting customized or filtered entities.

For example, the “General” context 220 has a set of canvases 230 that include a “Conversations” canvas, a “Files” canvas, a “Notes” canvas, a “Project Board” canvas, a “The OneNote” canvas, a “shipped” canvas and 8 additional canvases that are not displayed but still accessible (e.g., using a pulldown or a popup menu and the like). As discussed above, each canvas 230 has associated content or entities that have been filtered or otherwise selected for display in the workspace 240 of the particular canvas 230.

In this example, the “Files” canvas has been selected. The workspace 240 shows different files that are accessible to the user. A user may select a particular file in the workspace and access and edit the selected file. Additional files may also be added to the workspace using the upload and/or new buttons provided in the workspace 240.

Even though a new group and context has been selected, a user may return to the previous context and select the different canvases such as described above.

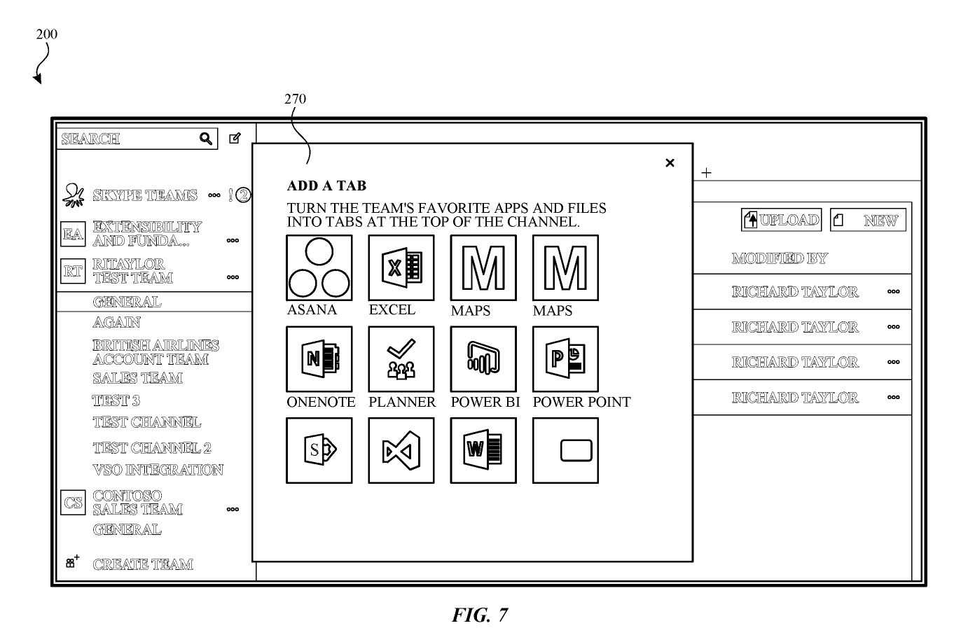

FIG. 7 illustrates an example user interface 200 that enables creation of a new canvas. In this example, when a user provides input to add a canvas (or a tab), a content selection screen 270 is provided in the user interface 200. The content selection screen 270 enables a user to select one or more services from which an entity may be added. The service may a third party or external service (e.g., video content website) or may be a local service (e.g., a word processing application) hosted by a server computing device or stored locally on a client device on which the user interface 200 is provided.

In some embodiments, a canvas may be created or added by selecting an entity that is stored locally on the client device or stored in the cloud. Once the entity is selected, a new canvas may be automatically generated and the entity may be provided in the workspace 240. In other embodiments, the service may be notified about the context and/or the canvas and the service may cause the canvas to be automatically created. The service may also populate the newly created canvas with a particular entity.

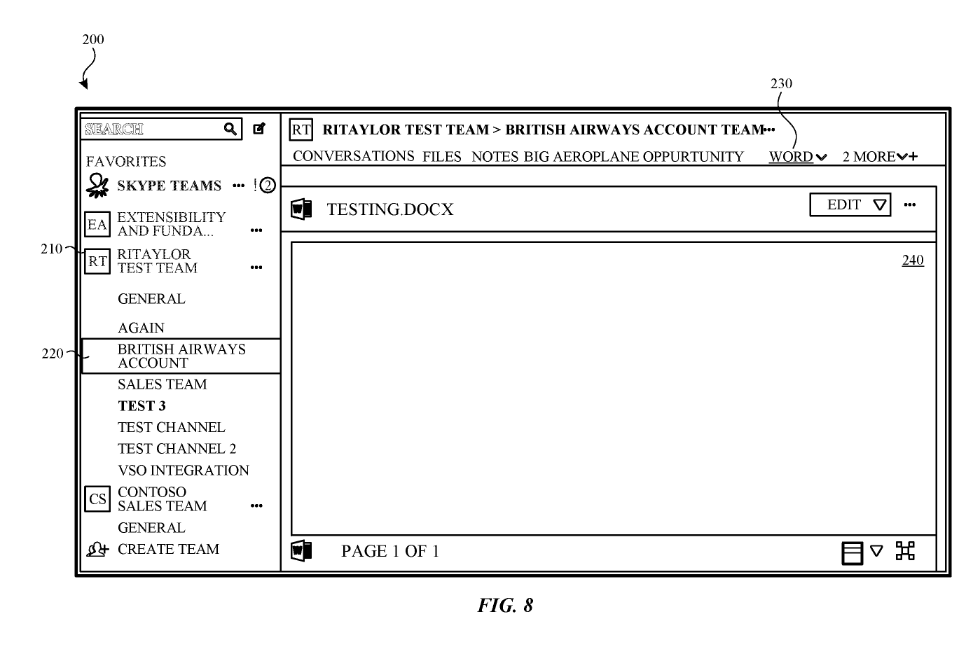

For example and turning to FIG. 8, if the user selects a Word document during the canvas creation operation, a “Word” canvas 230 may be created and an associated Word document may be provided in the workspace 240. Thus, a canvas 230 may provide users with various files (such as shown in FIG. 6) that a user may access or otherwise open. In another implementation, a canvas 230 may be used to provide direct access to a particular file.

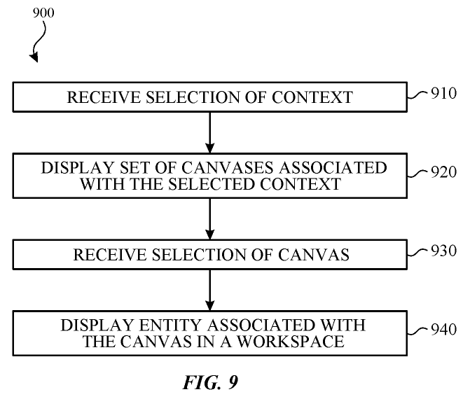

FIG. 9 illustrates a method 900 for displaying contextual canvases in a collaborative workspace environment. In some embodiments, the method 900 may be used to show or provide various canvases in a user interface of a collaborative workspace environment.

Method 900 begins at operation 910 in which a selection of a particular context is received. As discussed above, the context may be a channel, a chat, a conversation, a tenant, a team and so on associated with a particular group. Flow then proceeds to operation 920 and a set of canvases associated with the selected context is displayed.

In operation 930 at least one canvas from the set of canvases is selected. Once selected, one or more entities that are associated or otherwise filtered for that canvas, is provided in a workspace associated. Once displayed, the content of the entity may be access, edited, commented on, and so on.

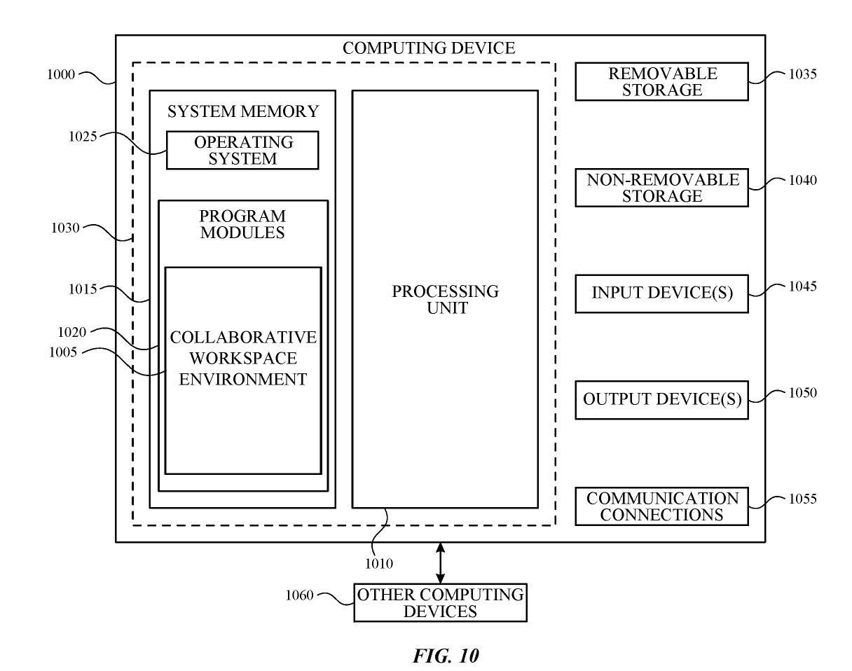

FIGS. 10-13 and the associated descriptions provide a discussion of a variety of operating environments in which aspects of the disclosure may be practiced. However, the devices and systems illustrated and discussed with respect to FIGS. 10-13 are for purposes of example and illustration and are not limiting of a vast number of electronic device configurations that may be utilized for practicing aspects of the disclosure, as described herein.

FIG. 10 is a block diagram illustrating physical components (e.g., hardware) of an electronic device 1000 with which aspects of the disclosure may be practiced. The computing device components described below may be suitable for the computing devices described above, including the client computing devices 110A and 110B and the server computing device 120.

In a basic configuration, the electronic device 1000 may include at least one processing unit 1010 and a system memory 1015. Depending on the configuration and type of electronic device, the system memory 1015 may comprise, but is not limited to, volatile storage (e.g., random access memory), non-volatile storage (e.g., read-only memory), flash memory, or any combination of such memories.

The operating system 1025, for example, may be suitable for controlling the operation of the electronic device 1000. Furthermore, embodiments of the disclosure may be practiced in conjunction with a graphics library, other operating systems, or any other application program and is not limited to any particular application or system. This basic configuration is illustrated in FIG. 10 by those components within a dashed line 1030.

The electronic device 1000 may have additional features or functionality. For example, the electronic device 1000 may also include additional data storage devices (removable and/or non-removable) such as, for example, magnetic disks, optical disks, or tape. Such additional storage is illustrated in FIG. 10 by a removable storage device 1035 and a non-removable storage device 1040.

As stated above, a number of program modules and data files may be stored in the system memory 1015. While executing on the processing unit 1010, the program modules 1020 (e.g., the content sharing module 1005) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 1000 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The electronic device 1000 may also have one or more input device(s) 1045 such as a keyboard, a trackpad, a mouse, a pen, a sound or voice input device, a touch, force and/or swipe input device, etc. The output device(s) 1050 such as a display, speakers, a printer, etc. may also be included. The aforementioned devices are examples and others may be used. The electronic device 1000 may include one or more communication connections 1055 allowing communications with other electronic devices 1060. Examples of suitable communication connections 1055 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 1015, the removable storage device 1035, and the non-removable storage device 1040 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 1000. Any such computer storage media may be part of the electronic device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

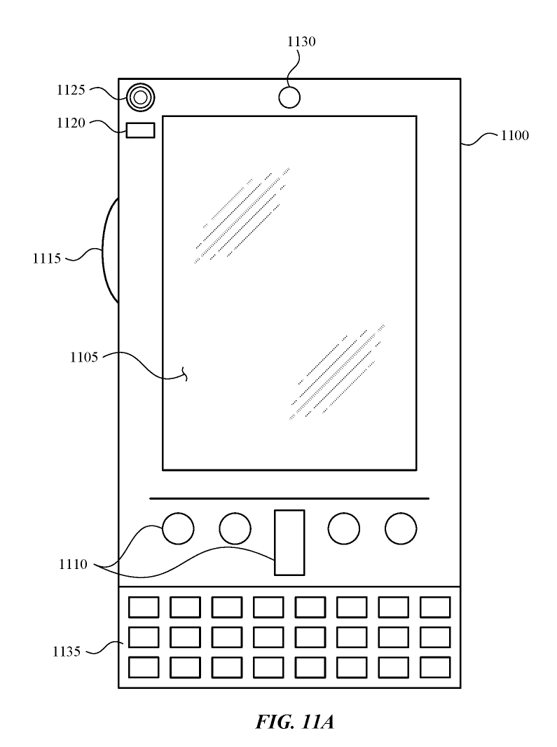

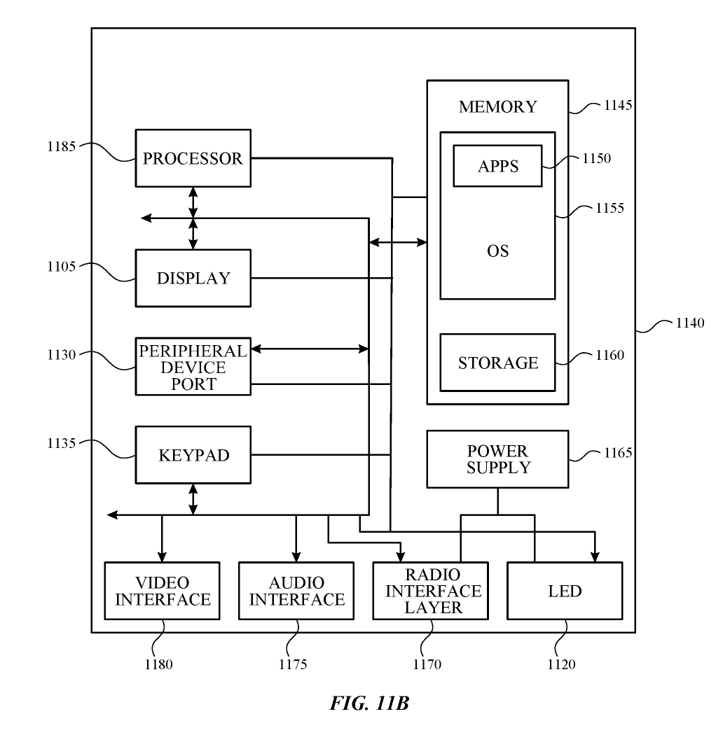

FIGS. 11A and 11B illustrate a mobile electronic device 1100, for example, a mobile telephone, a smart phone, wearable computer (such as a smart watch), a tablet computer, a laptop computer, and the like, with which embodiments of the disclosure may be practiced. With reference to FIG. 11A, one aspect of a mobile electronic device 1100 for implementing the aspects is illustrated.

In a basic configuration, the mobile electronic device 1100 is a handheld computer having both input elements and output elements. The mobile electronic device 1100 typically includes a display 1105 and one or more input buttons 1110 that allow the user to enter information into the mobile electronic device 1100. The display 1105 of the mobile electronic device 1100 may also function as an input device (e.g., a display that accepts touch and/or force input).

If included, an optional side input element 1115 allows further user input. The side input element 1115 may be a rotary switch, a button, or any other type of manual input element. In alternative aspects, mobile electronic device 1100 may incorporate more or less input elements. For example, the display 1105 may not be a touch screen in some embodiments. In yet another alternative embodiment, the mobile electronic device 1100 is a portable phone system, such as a cellular phone. The mobile electronic device 1100 may also include an optional keypad 1135. Optional keypad 1135 may be a physical keypad or a “soft” keypad generated on the touch screen display.

In various embodiments, the output elements include the display 1105 for showing a graphical user interface (GUI), a visual indicator 1120 (e.g., a light emitting diode), and/or an audio transducer 1125 (e.g., a speaker). In some aspects, the mobile electronic device 1100 incorporates a vibration transducer for providing the user with tactile feedback. In yet another aspect, the mobile electronic device 1100 incorporates input and/or output ports, such as an audio input (e.g., a microphone jack), an audio output (e.g., a headphone jack), and a video output (e.g., a HDMI port) for sending signals to or receiving signals from an external device.

FIG. 11B is a block diagram illustrating the architecture of one aspect of a mobile electronic device 1100. That is, the mobile electronic device 1100 can incorporate a system (e.g., an architecture) 1140 to implement some aspects. In one embodiment, the system 1140 is implemented as a “smart phone” capable of running one or more applications (e.g., browser, e-mail, calendaring, contact managers, messaging clients, games, media clients/players, content selection and sharing applications and so on). In some aspects, the system 1140 is integrated as an electronic device, such as an integrated personal digital assistant (PDA) and wireless phone.

One or more application programs 1150 may be loaded into the memory 1145 and run on or in association with the operating system 1155. Examples of the application programs include phone dialer programs, e-mail programs, personal information management (PIM) programs, word processing programs, spreadsheet programs, Internet browser programs, messaging programs, and so forth.

The system 1140 also includes a non-volatile storage area 1160 within the memory 1145. The non-volatile storage area 1160 may be used to store persistent information that should not be lost if the system 1140 is powered down.

The application programs 1150 may use and store information in the non-volatile storage area 1160, such as email or other messages used by an email application, and the like. A synchronization application (not shown) also resides on the system 1140 and is programmed to interact with a corresponding synchronization application resident on a host computer to keep the information stored in the non-volatile storage area 1160 synchronized with corresponding information stored at the host computer.

The system 1140 has a power supply 1165, which may be implemented as one or more batteries. The power supply 1165 may further include an external power source, such as an AC adapter or a powered docking cradle that supplements or recharges the batteries.

The system 1140 may also include a radio interface layer 1170 that performs the function of transmitting and receiving radio frequency communications. The radio interface layer 1170 facilitates wireless connectivity between the system 1140 and the “outside world,” via a communications carrier or service provider. Transmissions to and from the radio interface layer 1170 are conducted under control of the operating system 1155. In other words, communications received by the radio interface layer 1170 may be disseminated to the application programs 1150 via the operating system 1155, and vice versa.

The visual indicator 1120 may be used to provide visual notifications, and/or an audio interface 1175 may be used for producing audible notifications via an audio transducer (e.g., audio transducer 1125 illustrated in FIG. 11A). In the illustrated embodiment, the visual indicator 1120 is a light emitting diode (LED) and the audio transducer 1125 may be a speaker. These devices may be directly coupled to the power supply 1165 so that when activated, they remain on for a duration dictated by the notification mechanism even though the processor 1185 and other components might shut down for conserving battery power. The LED may be programmed to remain on indefinitely until the user takes action to indicate the powered-on status of the device.

The audio interface 1175 is used to provide audible signals to and receive audible signals from the user (e.g., voice input such as described above). For example, in addition to being coupled to the audio transducer 1125, the audio interface 1175 may also be coupled to a microphone to receive audible input, such as to facilitate a telephone conversation. In accordance with embodiments of the present disclosure, the microphone may also serve as an audio sensor to facilitate control of notifications, as will be described below.

The system 1140 may further include a video interface 1180 that enables an operation of peripheral device 1130 (e.g., on-board camera) to record still images, video stream, and the like.

A mobile electronic device 1100 implementing the system 1140 may have additional features or functionality. For example, the mobile electronic device 1100 may also include additional data storage devices (removable and/or non-removable) such as, magnetic disks, optical disks, or tape. Such additional storage is illustrated in FIG. 11B by the non-volatile storage area 1160.

Data/information generated or captured by the mobile electronic device 1100 and stored via the system 1140 may be stored locally on the mobile electronic device 1100, as described above, or the data may be stored on any number of storage media that may be accessed by the device via the radio interface layer 1170 or via a wired connection between the mobile electronic device 1100 and a separate electronic device associated with the mobile electronic device 1100, for example, a server computer in a distributed computing network, such as the Internet. As should be appreciated such data/information may be accessed via the mobile electronic device 1100 via the radio interface layer 1170 or via a distributed computing network. Similarly, such data/information may be readily transferred between electronic devices for storage and use according to well-known data/information transfer and storage means, including electronic mail and collaborative data/information sharing systems.

As should be appreciated, FIG. 11A and FIG. 11B are described for purposes of illustrating the present methods and systems and is not intended to limit the disclosure to a particular sequence of steps or a particular combination of hardware or software components.

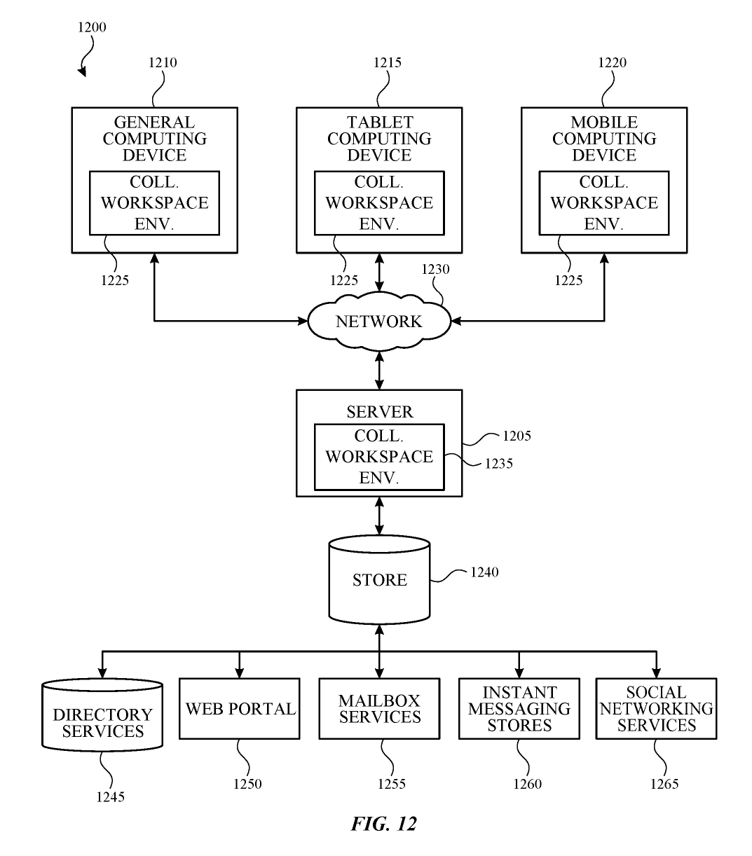

FIG. 12 illustrates one aspect of the architecture of a system 1200 such as described herein. The system may include a general electronic device 1210 (e.g., personal computer), tablet electronic device 1215, or mobile electronic device 1220, as described above. Each of these devices may include an interface for a collaborative workspace environment 1225 such as described above. For example, each device may access a network 1230 to interact with a collaborative workspace environment 1235 hosted by the server 1205.

In some aspects, the collaborative workspace environment 1235 may receive various types of information or content that is stored by the store 1240 or transmitted from a directory service 1245, a web portal 1250, mailbox services 1255, instant messaging stores 1260, or social networking services 1265.

By way of example, the aspects described above may be embodied in a general electronic device 1210 (e.g., personal computer), a tablet electronic device 1215 and/or a mobile electronic device 1220 (e.g., a smart phone). Any of these embodiments of the electronic devices may obtain content from or provide data to the store 1240.

As should be appreciated, FIG. 12 is described for purposes of illustrating the present methods and systems and is not intended to limit the disclosure to a particular sequence of steps or a particular combination of hardware or software components.

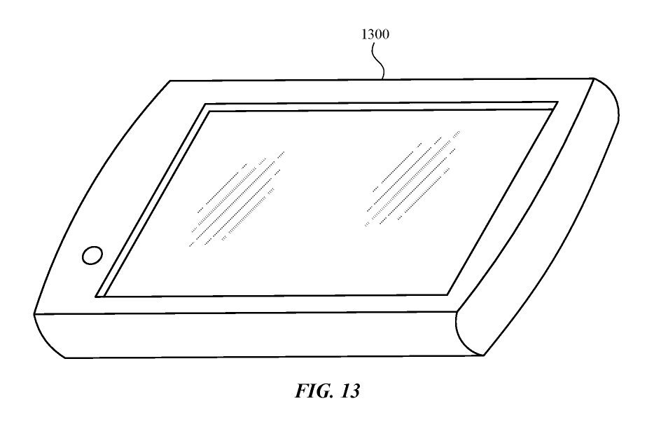

FIG. 13 illustrates an example tablet electronic device 1300 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more electronic devices.

For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated electronic device is equipped with detection (e.g., camera) functionality for capturing and interpreting user gestures for controlling the functionality of the electronic device, and the like.

As should be appreciated, FIG. 13 is described for purposes of illustrating the present methods and systems and is not intended to limit the disclosure to a particular sequence of steps or a particular combination of hardware or software components.

In other examples, disclosed herein is a system comprising: at least one processing unit; and at least one memory storing computer executable instructions which, when executed by the at least one processing unit, causes the system to provide a user interface for a collaborative workspace environment, the user interface comprising: a context selection area that displays one or more contexts, wherein each context of the one or more contexts is associated with a group in the collaborative workspace environment; a canvas selection area that displays one or more customizable canvases contextually associated with each of the one or more contexts, wherein: each of the one or more canvases is selectable; and selection of one of the one or more canvases causes a corresponding workspace to be displayed in the collaborative workspace environment, the corresponding workspace displaying a persistent entity that corresponds to the one of the one or more canvases and the context; and a conversation pane associated with at least one of the one or more contexts, the conversation pane for receiving and displaying input associated with at least one of the one or more canvases. In other examples, the system further comprises instructions for adding an additional canvas to the canvas selection area. In other examples, the additional canvas is created when an additional entity from a service is provided to the context. In other examples, the conversation pane is included in the one or more canvases. In other examples, the system further comprises instructions for displaying one or more different canvases in the canvas selection area when a different context is selected. In other examples, each canvas of the one or more different canvases in the canvas selection area provides an entity associated with the different context.

The present disclosure also describes a method comprising: receiving a selection of a context in a user interface of a collaborative workspace environment, the context being associated with a group in the collaborative workspace environment; displaying a set of selectable canvases associated with the context; receiving a selection of at least one canvas; displaying an entity that is contextually associated with the selected canvas and the context; and displaying a conversation pane, the conversation pane for receiving and displaying input that is associated with the context. In other examples, the method further comprises receiving input to add a new canvas to the user interface. In some examples, the new canvas is automatically associated with the context. In some examples, the entity is persistent. In some examples, the context is a chat session between a first member of the collaborative workspace environment and a second member of the collaborative workspace environment. In some examples, the context is a chat session between a first member of the collaborative workspace environment and multiple members of the collaborative workspace environment. In other examples, the method further comprises displaying a different set of canvases in response to a selection of a different context. In other examples, the method further comprises displaying a different entity when at least one of the different set of canvases is selected.

In yet another example, a computer-storage medium encoding computer-executable instructions which, when executed by a processing unit, provides a user interface for a collaborative workspace environment is disclosed. In some examples, the user interface comprises: a context selection area that displays one or more contexts associated with a group in the collaborative workspace environment; a canvas selection area that displays one or more customizable canvases, wherein each of the one or more customizable canvases is contextually associated with respective ones of the one or more contexts, and wherein: each of the one or more canvases is selectable; and selection of one of the one or more canvases causes a corresponding workspace to be displayed in the collaborative workspace environment, the corresponding workspace displaying an entity that corresponds to the one of the one or more canvases and the context; and a conversation pane for receiving and displaying input associated with at least one of the one or more contexts. In some examples, the computer-readable storage medium further comprises instructions for adding an additional canvas in response to received input. In some examples, the additional canvas is automatically associated with the context from which it was added. In some examples, the computer-readable storage medium further comprises instructions for displaying one or more different canvases in the canvas selection area when a different context is selected. In some examples, each canvas of the one or more different canvases in the canvas selection area provides an entity associated with the different context. In some examples, the entity is persistent.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processing unit; and
at least one memory storing computer executable instructions which, when executed by the at least one processing unit, causes the system to provide a user interface for a collaborative workspace environment, the user interface comprising:
a context selection area that displays one or more contexts, wherein each context of the one or more contexts is associated with a group in the collaborative workspace environment;
a canvas selection area that displays one or more customizable canvases contextually associated with each of the one or more contexts, wherein:
each of the one or more canvases is selectable; and
selection of one of the one or more canvases causes a corresponding workspace to be displayed in the collaborative workspace environment, the corresponding workspace displaying a persistent entity that corresponds to the one of the one or more canvases and the context; and
a conversation pane associated with at least one of the one or more contexts, the conversation pane for receiving and displaying input associated with at least one of the one or more canvases.

2. The system of claim 1, further comprising instructions for adding an additional canvas to the canvas selection area.

3. The system of claim 2, wherein the additional canvas is created when an additional entity from a service is provided to the context.

4. The system of claim 1, wherein the conversation pane is included in the one or more canvases.

5. The system of claim 1, further comprising instructions for displaying one or more different canvases in the canvas selection area when a different context is selected.

6. The system of claim 5, wherein each canvas of the one or more different canvases in the canvas selection area provides an entity associated with the different context.

7. A method comprising:
receiving a selection of a context in a user interface of a collaborative workspace environment, the context being associated with a group in the collaborative workspace environment;
displaying a set of selectable canvases associated with the context;
receiving a selection of at least one canvas;
displaying an entity that is contextually associated with the selected canvas and the context; and
displaying a conversation pane, the conversation pane for receiving and displaying input that is associated with the context.

8. The method of claim 7, further comprising receiving input to add a new canvas to the user interface.

9. The method of claim 8, wherein the new canvas is automatically associated with the context.

10. The method of claim 7, wherein the entity is persistent.

11. The method of claim 7, wherein the context is a chat session between a first member of the collaborative workspace environment and a second member of the collaborative workspace environment.

12. The method of claim 7, wherein the context is a chat session between a first member of the collaborative workspace environment and multiple members of the collaborative workspace environment.

13. The method of claim 7, further comprising displaying a different set of canvases in response to a selection of a different context.

14. The method of claim 13, further comprising displaying a different entity when at least one of the different set of canvases is selected.

15. A computer-storage medium encoding computer-executable instructions which, when executed by a processing unit, provides a user interface for a collaborative workspace environment, the user interface comprising:
a context selection area that displays one or more contexts associated with a group in the collaborative workspace environment;
a canvas selection area that displays one or more customizable canvases, wherein each of the one or more customizable canvases is contextually associated with respective ones of the one or more contexts, and wherein:
each of the one or more canvases is selectable; and
selection of one of the one or more canvases causes a corresponding workspace to be displayed in the collaborative workspace environment, the corresponding workspace displaying an entity that corresponds to the one of the one or more canvases and the context; and
a conversation pane for receiving and displaying input associated with at least one of the one or more contexts.

16. The computer-readable storage medium of claim 15, further comprising instructions for adding an additional canvas in response to received input.

17. The computer-readable storage medium of claim 16, wherein the additional canvas is automatically associated with the context from which it was added.

18. The computer-readable storage medium of claim 15, further comprising instructions for displaying one or more different canvases in the canvas selection area when a different context is selected.

19. The computer-readable storage medium of claim 18, wherein each canvas of the one or more different canvases in the canvas selection area provides an entity associated with the different context.

20. The computer-readable storage medium of claim 15, wherein the entity is persistent.
